(19) United States
(12) Patent Application Publication
(10) Pub. No.: US 2026/0346388 A1
(43) Pub. Date: Nov. 5, 2026

(54) LOCKABLE MULTI-AXIS MACHINE TOOL FIXTURE FOR HOLDING WORKPIECE IN VARIABLE POSITIONS

(71) Applicant: Rolls-Royce Corporation, Indianapolis, IN (US)

(72) Inventors: Rusty Garner, Indianapolis, IN (US); Damon Ward, Indianapolis, IN (US); Monica Munoz, Indianapolis, IN (US)

(21) Appl. No.: 19/195,700

(22) Filed: Apr. 30, 2025

(51) Int. Cl. B23Q 1/44

(52) U.S. Cl. CPC B23Q 1/44

(57) ABSTRACT

A machine tool system includes a workpiece, a machine that modifies the workpiece, and a tool base that includes a gimbal assembly that supports the workpiece and enables adjustment of the workpiece with six degrees of freedom and can be arranged in the machine. The gimbal assembly includes a base support body, an adjustable body supported by the base support body and movable relative thereto, and a central support body arranged within and supported by the adjustable body and configured to fixedly hold the workpiece. The adjustable body can be selectively moved relative to the base support body to cause or enable movement of the central support body relative to the base support body in one or more of the six degrees of freedom so as to adjust a position of the workpiece relative to the base support body.

### FIELD OF THE DISCLOSURE

The present disclosure relates generally to machine tool systems, and more specifically to workpiece supports of machine tool systems.

### BACKGROUND

Electrochemical machining (ECM) is a non-contact, non-thermal material removal process capable of small features, high quality surfaces, and high repeatability for production parts. Pulsed electrochemical machining (PECM), sometimes called precision electrochemical machining, is a more precise variant of ECM that uses a pulsed power supply.

Unlike many other manufacturing processes, there is no contact between the machining component or tool bit, which may be referred to as a cathode, and the workpiece in PECM. Material of the workpiece in close proximity to the machining component is dissolved by an electrochemical process, and the by-products are flushed away with a flowing electrolyte. The resulting workpiece has the shape that is an inverse of the machining component.

PECM provides some advantages over other manufacturing processes. For example, PECM may be used for relatively hard materials that may be difficult to machine using conventional methods. As another example, PECM can be used to machine small, intricate, or complex shapes or contours with a relatively high surface quality. Some workpieces may be easily distorted or non-repositionable and, thus, difficult to reposition during PECM.

### SUMMARY

The present disclosure may comprise one or more of the following features and combinations thereof.

According to a first aspect of the present disclosure, a machine tool system includes a thin-walled three-dimensional workpiece, a machine configured to modify the thin-walled three-dimensional workpiece, the machine including a shaft configured to move along a first axis, and a tool base. The tool base is configured to support the thin-walled three-dimensional workpiece, the tool base including a gimbal assembly that supports the thin-walled three-dimensional workpiece and that enables adjustment of the thin-walled three-dimensional workpiece with six degrees of freedom, the gimbal assembly being configured to be arranged in the machine for machining the thin-walled three-dimensional workpiece, the gimbal assembly including a base support body and at least one adjustable body supported by the base support body and movable relative thereto, the gimbal assembly further including a central support body arranged at least partially within and supported by the at least one adjustable body, the central support body configured to fixedly hold the thin-walled three-dimensional workpiece. The shaft is movable relative to the gimbal assembly when the gimbal assembly is arranged in the machine so as to modify the thin-walled three-dimensional workpiece.

In some embodiments, the at least one adjustable body is configured to be selectively moved relative to the base support body, selective movement of the at least one adjustable body causes or enables movement of the central support body relative to the base support body in one or more of the six degrees of freedom so as to adjust a position of the thin-walled three-dimensional workpiece relative to the base support body.

In some embodiments, the at least one adjustable body includes a first adjustable body that is arranged partially below the central support body and that is movable relative to the base support body, the first adjustable body supports the central support body, and rotation of the first adjustable body in a first rotational direction causes the central support body to move in an upward direction relative to the base support body and rotation of the first adjustable body in a second rotational direction opposite the first rotational direction causes the central support body to move in a downward direction opposite the upward direction relative to the base support body.

In some embodiments, the at least one adjustable body further includes a second adjustable body that surrounds the central support body and that is rotatable independently of the first adjustable body and relative to the base support body, the second adjustable body is configured to be rotated relative to the first adjustable body in a first rotational direction to a tightened position in which the second adjustable body contacts the central support body and holds the central support body in a fixed position relative to the base support body, and is configured to be rotated in a second rotational direction opposite the first rotational direction to a loosened position in which the second adjustable body is spaced apart from the central support body to allow for movement of the central support body relative to the second adjustable body and the base support body.

In some embodiments, the second adjustable body being in the loosened position allows for the central support body to move in positive and negative yaw directions, positive and negative roll directions, and positive and negative pitch directions.

In some embodiments, the first adjustable body rests on and is supported by an upper surface of the base support body and includes a bottom surface that is configured to slide along the upper surface such that the first adjustable body can rotate on the upper surface.

In some embodiments, the at least one adjustable body further includes a third adjustable body arranged between the first and second adjustable bodies in a vertical direction, the third adjustable body surrounds the central support body and includes an opening therethrough having a sloped bottom portion that supports the central support body therein, and the first adjustable body engages the third adjustable body such that rotation of the first adjustable body in the first rotational direction moves the third adjustable body in the upward direction so as to move the central support body in the upward direction.

In some embodiments, the first adjustable body is a first annular ring including a bottom surface that rests on an upper surface of the base support body and is configured to slide along the upper surface such that the first annular ring can rotate on the upper surface, and the second adjustable body is a second annular ring that surrounds the central support body.

In some embodiments, the at least one adjustable body further includes a third adjustable body that is a third annular ring that surrounds the central support body and is arranged between the first and second annular rings in a vertical direction, the third annular ring includes an inner surface that supports the central support body, and the first annular ring includes a threaded inner surface and the third annular ring includes a lower threaded outer surface that engages the threaded inner surface of the first annular ring such that rotation of the first annular ring in the first rotational direction moves the third annular ring in the upward direction so as to move the central support body in the upward direction.

In some embodiments, the second annular ring is configured to be rotated in a first rotational direction to a tightened position in which an inner surface of the second annular ring contacts the central support body and holds the central support body in a fixed position relative to the base support body, and is configured to be rotated in a second rotational direction opposite the first rotational direction to a loosened position in which the second annular ring is spaced apart from the central support body to allow for movement of the central support body relative to the second annular ring and the base support body.

In some embodiments, the central support body includes a sloped annular upper portion and a sloped annular lower portion, the inner surface of the third annular ring includes a sloped bottom portion that supports the sloped annular lower portion of the central support body therein, the sloped bottom portion and the sloped annular lower portion of the central support body have corresponding curvatures to allow for rotation of the central support body within the third annular ring, the second annular ring includes an inner surface having a sloped annular upper portion corresponding to the sloped annular upper portion of the central support body, and, in the tightened position of the second annular ring, the sloped annular upper portion of the second annular ring contacts and exerts a force on the sloped annular upper portion of the central support body so as to push the sloped annular lower portion into secure engagement with the sloped bottom portion of the third annular ring so as to hold the central support body in a fixed position relative to the first, second, and third annular rings and to the base support body.

In some embodiments, the inner surface of the second annular ring includes a threaded lower inner surface, the third annular ring includes an upper threaded outer surface that engages the threaded lower inner surface of the second annular ring, and the second annular ring is configured to be rotated relative to the third annular ring via the threaded lower inner surface and the upper threaded outer surface so as to move the second annular ring between the tightened and loosened positions.

In some embodiments, the gimbal assembly further includes a first clamp arranged on a first side of the base support body and selectively fastened to the base support body via at least one first fastener, and a second clamp arranged on a second side of the base support body opposite the first side and selectively fastened to the base support body via at least one second fastener, the first annular ring includes an annular groove formed in an outer surface of the first annular ring, the first clamp includes a first curved flange that extends into the groove and the second clamp includes a second curved flange that extends into the groove, the at least one first and second fasteners are configured to tightened and loosened so as to selectively arrange the first annular ring in a tightened or loosened state, inner surfaces of the first and second flanges are spaced apart from a bottom surface of the groove such that, in the loosened state of the first annular ring, the first annular ring can be translated left-to-right, right-to-left, forward-to-backward, and backward-to-forward on the upper surface of the base support body.

In some embodiments, the tool base further includes a base platform and a chuck arranged on the base platform, the gimbal assembly is configured to be arranged in the chuck prior arranging the gimbal assembly in the machine, and the position of the thin-walled three-dimensional workpiece relative to the gimbal assembly is configured to be adjusted while the gimbal assembly is arranged in the chuck and locked in a locked position in the gimbal assembly such that the gimbal assembly and having the thin-walled three-dimensional workpiece arranged therein is configured to be arranged in the machine with the thin-walled three-dimensional workpiece in the locked position.

According to a further aspect of the present disclosure, a gimbal assembly for supporting a workpiece relative to a machine configured to modify the workpiece includes a base support body, at least one adjustable body supported by the base support body and movable relative thereto, and a central support body arranged at least partially within and supported by the at least one adjustable body, the central support body configured to fixedly hold a workpiece.

In some embodiments, the at least one adjustable body is configured to be selectively moved relative to the base support body, selective movement of the at least one adjustable body causes or enables movement of the central support body relative to the base support body in one or more of the six degrees of freedom so as to adjust a position of the workpiece relative to the base support body.

In some embodiments, the at least one adjustable body includes a first adjustable body that is arranged partially below the central support body and that is rotatable relative to the base support body, the first adjustable body supports the central support body, and rotation of the first adjustable body in a first rotational direction causes the central support body to move in an upward direction relative to the base support body and rotation of the first adjustable body in a second rotational direction opposite the first rotational direction causes the central support body to move in a downward direction opposite the upward direction relative to the base support body.

In some embodiments, the at least one adjustable body further includes a second adjustable body that surrounds the central support body and that is rotatable independently of the first adjustable body and relative to the base support body, the second adjustable body is configured to be rotated in a first rotational direction to a tightened position in which the second adjustable body contacts the central support body and holds the central support body in a fixed position relative to the base support body, and is configured to be rotated in a second rotational direction opposite the first rotational direction to a loosened position in which the second adjustable body is spaced apart from the central support body to allow for movement of the central support body relative to the second adjustable body and the base support body, and the first adjustable body rests on and is supported by an upper surface of the base support body and includes a bottom surface that is configured to slide along the upper surface such that the first adjustable body can rotate on the upper surface.

In some embodiments, the at least one adjustable body further includes a third adjustable body arranged between the first and second adjustable bodies in a vertical direction, the third adjustable body surrounds the central support body and includes an opening therethrough having a sloped bottom portion that supports the central support body therein, and the first adjustable body engages the third adjustable body such that rotation of the first adjustable body in the first rotational direction moves the third adjustable body in the upward direction so as to move the central support body in the upward direction.

According to a further aspect of the present disclosure, a method includes providing a base support body of a gimbal assembly, arranging at least one adjustable body on the base support body, the at least one adjustable body is supported by the base support body and is movable relative thereto, arranging a central support body at least partially within the at least one adjustable body such that the at least one adjustable body at least partially supports the central support body, fixedly arranging a workpiece configured to be modified by a machine in the central support body, and selectively moving the at least one adjustable body relative to the base support body so as to cause or enable movement of the central support body relative to the base support body in one or more of the six degrees of freedom so as to adjust a position of the workpiece relative to the base support body.

In some embodiments, the at least one adjustable body includes a first adjustable body that is arranged partially below the central support body and that is rotatable relative to the base support body, the first adjustable body supports the central support body, and the method further includes rotating the first adjustable body in a first rotational direction so as to cause the central support body to move in an upward direction relative to the base support body, and rotating the first adjustable body in a second rotational direction opposite the first rotational direction so as to cause the central support body to move in a downward direction opposite the upward direction relative to the base support body.

In some embodiments, the at least one adjustable body further includes a second adjustable body that surrounds the central support body and that is rotatable independently of the first adjustable body and relative to the base support body, the second adjustable body is configured to be rotated in a first rotational direction and a second rotational direction opposite the first rotational direction, and the method further includes arranging the central support body in a neutral position within the first and second adjustable bodies, rotating the second adjustable body in the second rotational direction to a loosened position in which the second adjustable body is slightly spaced apart from the central support body and allows for movement of the central support body relative to the second adjustable body and the base support body, adjusting a position of the central support body relative to the first and second adjustable bodies and the base support body to a second position different than the neutral position, and rotating the second adjustable body in the first rotational direction to a tightened position in which the second adjustable body contacts the central support body and holds the central support body in a fixed position relative to the first and second adjustable bodies and the base support body, the fixed position being the second position.

These and other features of the present disclosure will become more apparent from the following description of the illustrative embodiments.

### BRIEF DESCRIPTION OF THE DRAWINGS

FIG. 1 is a perspective view of a machine tool system according to the present disclosure, showing that the system includes a workpiece, a machine configured to modify the workpiece, and a tool base having a first locating frame, a second locating frame, and a gimbal assembly that supports the thin-walled three-dimensional workpiece and that enables adjustment of the workpiece with six degrees of freedom;

FIG. 2 is a perspective view of the gimbal assembly of FIG. 1, showing that the gimbal assembly includes a base support body and at least one adjustable body supported by the base support body and movable relative thereto, the gimbal assembly further including a central support body arranged at least partially within and supported by the at least one adjustable body, the central support body configured to fixedly hold the workpiece, and showing that the at least one adjustable body includes three annular rings that are rotatable relative to each other in order to allow for the six degrees of freedom of adjustment of the workpiece;

FIG. 3 is a perspective view of the gimbal assembly of FIG. 2 with the three annular rings removed, showing the central support body and the base support body, and showing clamps arranged on opposing sides of the base support body that are configured to secure the lower annular ring in position on the base support body;

FIG. 4 is a front view of the gimbal assembly of FIG. 3 with the three annular rings removed, showing the central support body and the base support body including the clamps;

FIG. 5A is top perspective view of the lower annular ring of the gimbal assembly of FIG. 2, showing that the lower annular ring defines a central annular cavity having a threaded inner surface, and the ring having an annular groove formed in an outer surface of the ring;

FIG. 5B is a top perspective view of the middle annular ring of the gimbal assembly of FIG. 2, showing that the middle annular ring includes an upper threaded outer surface, a lower threaded outer surface spaced apart from the upper threaded outer surface, and a central annular flange between the upper and lower threaded outer surfaces, and showing that the ring defines a central annular cavity therein, the central annular cavity having a cylindrical upper portion and a sloped bottom portion corresponding to a sloped annular lower portion of the central support body;

FIG. 5C is a bottom perspective view of the middle annular ring of the gimbal assembly of FIG. 2, showing that the lower threaded outer surface terminates at a bottom annular platform of the ring having a central opening formed therein, the sloped bottom portion of the annular cavity of the middle annular ring opening outwardly at the central opening of the bottom annular platform;

FIG. 5D is a top perspective view of the upper annular ring of the gimbal assembly of FIG. 2, showing that the upper annular ring defines a central annular cavity having a threaded inner surface, and the ring having an upper annular platform having a central opening formed therein;

FIG. 5E is a bottom perspective view of the upper annular ring of the gimbal assembly of FIG. 2, showing that the central annular cavity of the upper annular ring includes the threaded inner surface formed on a lower portion of the inner surface and a sloped annular upper portion corresponding to a sloped annular upper portion of the central support body;

FIG. 6 is a front view of the gimbal assembly of FIG. 2 with only the lower annular ring surrounding the central support body, showing curved flanges of the clamps of the base support body arranged in the annular groove of the lower annular ring;

FIG. 7 is a front view of the gimbal assembly of FIG. 2 with all three of the annular rings surrounding the central support body;

FIG. 8 is a front cross-sectional view of the gimbal assembly of FIG. 2 taken through line 8-8 of FIG. 9, showing how each ring is threadably engaged with the adjacent ring such that rotation of the rings causes or enables movement of the central support body relative to the base support body in one or more of the six degrees of freedom so as to adjust a position of the workpiece relative to the base support body;

FIG. 9 is a top cross-sectional view of the gimbal assembly of FIG. 2 taken through line 9-9 of FIG. 8, showing the various degrees of freedom that the movement of the central support body relative to the base support body can be moved in;

FIG. 10 is a front cross-sectional view of the gimbal assembly of FIG. 2 taken through line 8-8 of FIG. 9, showing the middle annular ring having been raised in the upward direction via rotation of the lower annular ring; and

FIG. 11 is a front cross-sectional view of the gimbal assembly of FIG. 2 taken through line 8-8 of FIG. 9, showing the upper annular ring having been raised in the upward direction via rotation of the upper annular ring so as to allow for movement of the central support body within the middle annular ring.

### DETAILED DESCRIPTION

For the purposes of promoting an understanding of the principles of the disclosure, reference will now be made to a number of illustrative embodiments illustrated in the drawings and specific language will be used to describe the same.

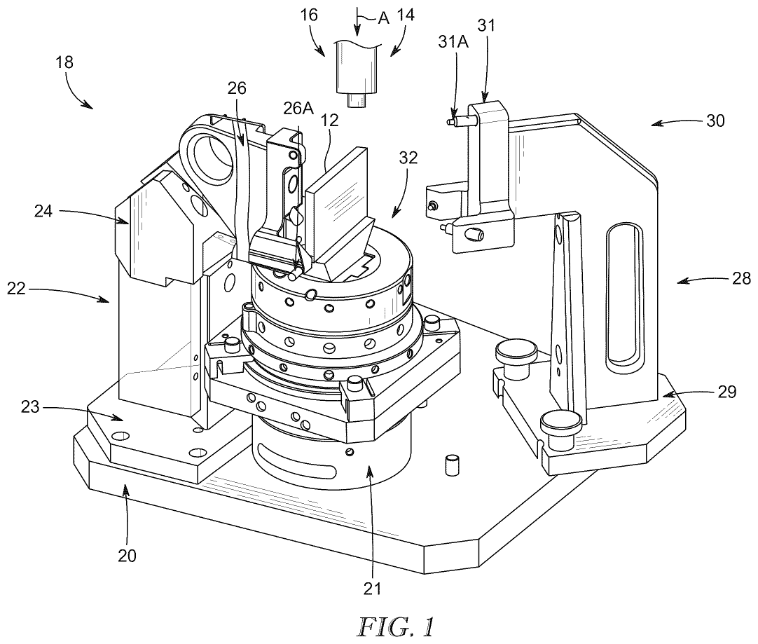

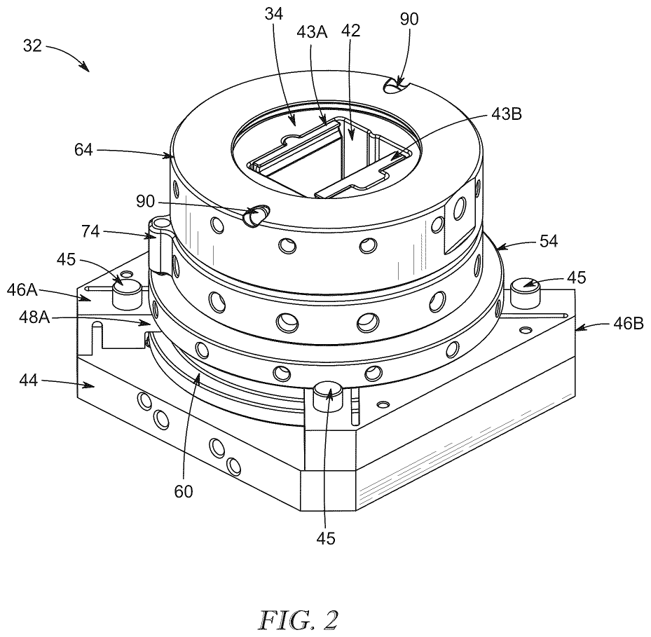

A machine tool system 10 includes a workpiece 12, a machine 14 having a shaft 16, and a tool base 18 (also referred to as a “loading station”), as shown in FIG. 1. In illustrative embodiments, the workpiece 12 is a thin-walled three-dimensional workpiece. The machine 14 is configured to modify the workpiece 12. As will be described below, components of the tool base 18, namely a first locating frame 22 and a second locating frame 28, support the workpiece 12 prior to the workpiece 12 being inserted into the machine 14 via the gimbal assembly 32. The first and second locating frames 22, 28 are repositionable and relocatable relative to the a base platform 20 in different positions so as to aid in positioning the workpiece 12 within the gimbal assembly 32 prior to finalizing the workpiece 12 position within the gimbal assembly 32 and then inserting the gimbal assembly 32 along with the workpiece 12 into the machine 14 for machining.

The machine 14 can include a shaft 16, as shown in FIG. 1. The machine 14 can further include a chuck (not shown) that is supported on a base (not shown) of the machine that is same as a chuck 21 arranged on the base platform 20 of the tool base 18, as will be described in detail below. The gimbal assembly 32 supports the workpiece 12 and is configured to be arranged in the machine 14 in order to position the workpiece in a fixed position relative to the shaft 16. The shaft 16 is spaced apart from the gimbal assembly 32 when the gimbal assembly 32 is arranged in the machine 14 and moves along a first axis A to modify the workpiece 12.

In some embodiments, the machine 14 is capable of pulsed electrochemical machining (PECM). In such an embodiment, the shaft 16 or bit attached to the shaft 16 may be referred to as a cathode. To modify the workpiece 12, the shaft 16 moves toward the workpiece 12 and oscillates along the first axis A, but does not contact the workpiece 12. Once the shaft 16 is adjacent the workpiece 12 to form a gap therebetween, an electrolyte is injected into the gap. The electrolyte acts as an electron transfer medium to facilitate anodic dissolution of the material of the workpiece 12 adjacent the shaft 16. In some embodiments, the electrolyte may be a salt-based solution. The electrolyte allows electrical current to flow between the shaft 16 and the workpiece 12. Any by-products, such as, for example, metal hydroxides or hydrogen gas, of the electrochemical process are then flushed away by the electrolyte. The shaft 16 illustratively has a shape inverse to that of the desired workpiece 12 shape. In some embodiments, the shaft 16 may comprise titanium, stainless steel, copper, or any other suitable current carrying material.

Because PECM is a non-contact and non-thermal process, the workpiece 12 is not subjected to thermal or mechanical stresses. Additionally, because PECM is a non-contact and non-thermal process, the shaft 16 is not typically consumed or worn during the process of machining. In other embodiments, the machine 14 performs other subtractive or additive processes and may contact the workpiece 12. For example, the machine 14 may provide turning, milling, drilling, grinding, cutting, laser cutting, waterjet cutting, electrical discharge machining, plasma cutting, laser deposition, 3D printing, etc. A person skilled in the art will understand that, although the embodiments described herein refer to a machine 14 having a shaft 16, the machine 14 utilizing the gimbal assembly 32 described herein may not include a shaft 16 but may include other means of modifying the workpiece 12.

In some embodiments, the machine 14 is a single axis machine 14. In other words, the shaft 16 of the machine 14 only moves along the first axis A. Thus, to modify different sides of the workpiece 12, the workpiece 12 is repositioned such that the different sides may be modified by the shaft 16 moving along the first axis A. However, the workpiece 12 may be relatively thin and easily distorted or non-repositionable in conventional fixtures and any repositioning of the workpiece 12 itself may distort the workpiece 12. The tool base 18 of the present disclosure provides the ability to reposition the workpiece 12 relative to the machine 14, in particular relative to the shaft 16, prior to insertion of the gimbal assembly 32 of the tool base 18 into the machine 14.

The workpiece 12 is illustratively a thin-walled three-dimensional workpiece, as shown in FIG. 1. In some embodiments, the workpiece 12 may be used in a gas turbine engine. For example, the workpiece 12 may form a part of a vane or a blade of a gas turbine engine. The workpiece 12 may provide, by way of non-limiting example, a blade spar, vane spar, or coversheet for a pressure side and/or a suction side of a vane or a blade.

As shown in FIG. 1, the tool base 18 includes a base platform 20 and the first and second locator frames 22, 28. As described above, the first and second locator frames 22, 28 are selectively repositionable on the base platform 20. The tool base 18 further includes a chuck 21 that can be fixedly coupled in position on the base platform 20. The gimbal assembly 32 described herein is configured to be arranged on the chuck 21 prior to inserting the gimbal assembly 32 in the machine 14 for machining.

The position of the chuck 21 on the base platform 20 directly mimics the position of the chuck and base (not shown) of the machine 14 such that the workpiece 12 can be selectively adjusted and repositioned within the gimbal assembly 32 while the gimbal assembly 32 is outside of the machine 14. In this way, the workpiece 12 can be selectively moved to a desired machining position within the gimbal assembly 32 prior to arranging the gimbal assembly 32 along with the workpiece 12 within the machine 14. Having the reference of the chuck 21 on the base platform 20, which mimics the chuck and base of the machine 14 and thus provides a reference point of where the chuck and shaft 16 of the machine 14 will be located relative to the gimbal assembly 32 once inserted into the machine 14, enables a user to know exactly how to selectively move the workpiece 12 within the gimbal assembly 32 prior to insertion into the machine 14.

The first locating frame 22 is arranged on an upper surface of the base platform 20 which includes a lower base 23 that rests on the base platform 20 and an upper portion 24 having a workpiece holder 26. The workpiece holder 26 is configured to hold the workpiece 12 in place via spring-loaded plungers 26A, specifically in a relatively secure position, but while allowing for some play of the workpiece 12 relative to the holder 26 so as to allow for small adjustments of the position of the workpiece 12 while the workpiece 12 is arranged in the gimbal assembly 32. The first locating frame 22 is selectively positionable on the base platform 20 and can be moved about the base platform 20 until a desirable position of the first locating frame 22 relative to the chuck 21 is determined. In some embodiments, the first locating frame 22 may be secured to the base platform 20 once the locating frame 22 is arranged in the desired position on the platform 20.

Similarly, the tool base 18 can further include the second locating frame 28 arranged on the upper surface of the base platform 20 spaced apart from the first locating frame 22. The second locating frame 28 includes a lower base 29 that rests on the base platform 20 and an upper portion 30. In some embodiments, the upper portion 30 can further include additional holding means similar to the workpiece holder 26 to provide additional support to the workpiece 12 while it is arranged in the gimbal assembly 32, such as a second workpiece holder 31 and associated spring-loaded plungers 31A which contact and support the workpiece 12 in the gimbal assembly 32 while allowing for some play thereof.

The second locating frame 28 is selectively positionable on the base platform 20 and can be moved about the base platform 20 until a desirable position of the second locating frame 28 relative to the chuck 21 is determined. In some embodiments, the second locating frame 28 may be secured to the base platform 20 once the locating frame 28 is arranged in the desired position on the platform 20. The second locating frame 28 is configured to be moved into a position proximal to the first locating frame 22 in order to further support the workpiece 12 while it is adjusted within the gimbal assembly 32.

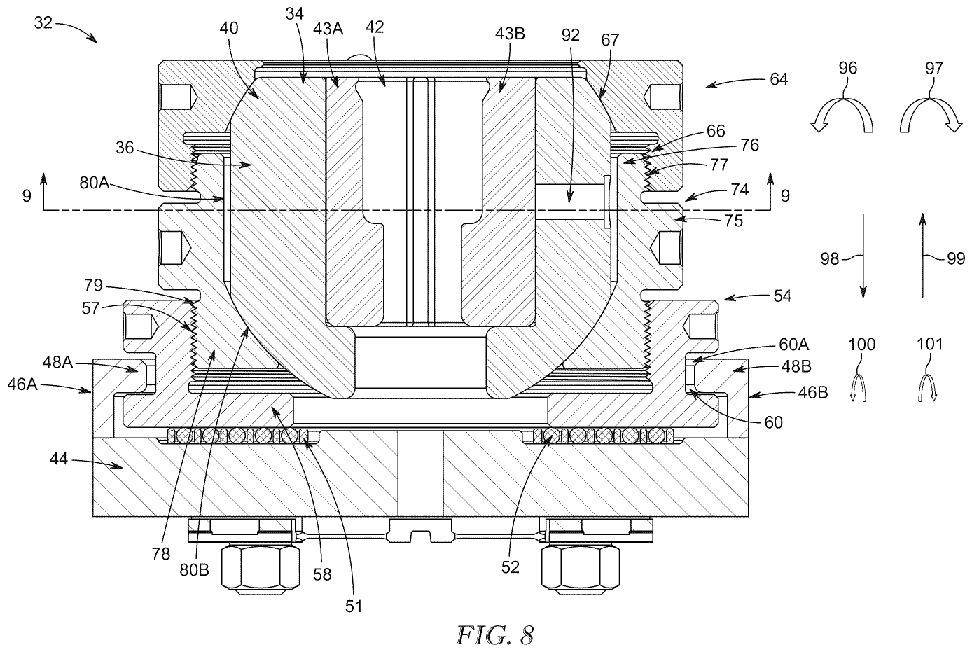

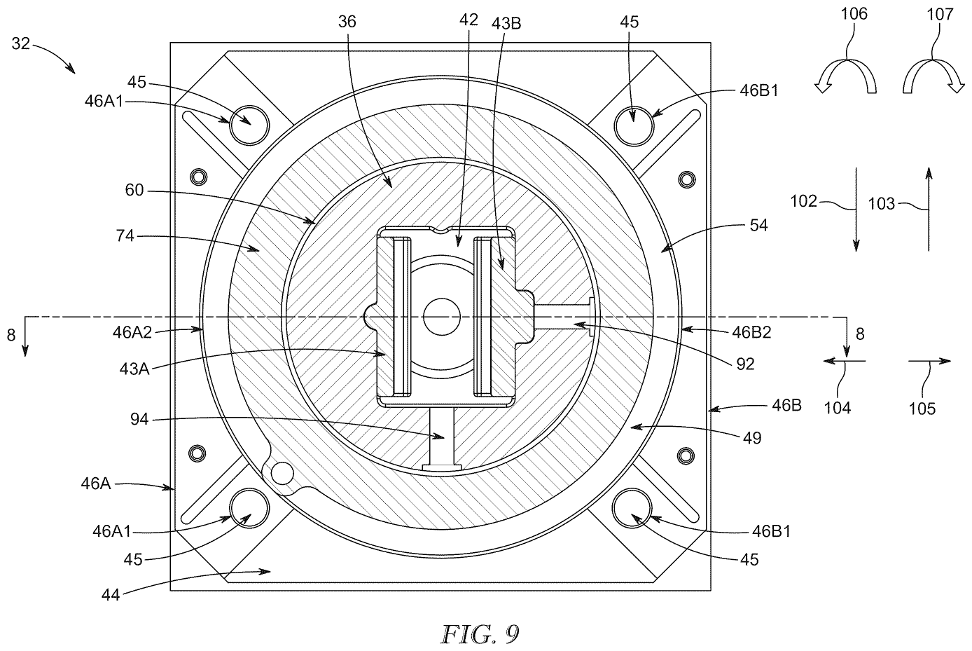

As shown in FIG. 1, the tool base 18 further includes the gimbal assembly 32 that can be arranged on top of the chuck 21 on the base platform 20. Illustratively, the chuck 21 is arranged in a fixed position of the base platform 20, although in some embodiments, the chuck 21 can be selectively repositionable on the base platform 20 and is selectively securable to the base platform 20. The gimbal assembly 32 is configured to support the thin-walled three-dimensional workpiece 12, and also to enable adjustment of the workpiece 12 of relative to the chuck 21 with six degrees of freedom. The six degrees of freedom, which are possible adjustment directions of the workpiece 12 within the gimbal assembly 32, are shown in FIGS. 8 and 9. These directions include, relative to a base support body 44 of the gimbal assembly 32, positive and negative pitch directions 96, 97, an upward-to-downward direction 98, a downward-to-upward direction 99, positive and negative roll directions 100, 101, a forward-to-backward direction 102, a backward-to-forward direction 103, a right-to-left direction 104, a left-to-right direction 105, and positive and negative yaw directions 106, 107.

In some embodiments, a method of selectively positioning the workpiece 12 relative to the gimbal assembly 32 for inserting the gimbal assembly 32 along with the workpiece 12 into a machine 14 for machining can include the following operational steps. First, the gimbal assembly 32, along with the workpiece 12, can be arranged in the chuck 21. The first locator frame 22 can be positioned adjacent to the gimbal assembly 32 such that the holder 26 can provide support to the workpiece 12 within the gimbal assembly 32 while allowing for some play of the workpiece 12 for adjustment of the workpiece 12 in the gimbal assembly 32. The second locator frame 28 can then be positioned adjacent to the gimbal assembly 32 such that the holder 31 can provide additional support to the workpiece 12 within the gimbal assembly 32 while allowing for some play of the workpiece 12 for adjustment of the workpiece 12 in the gimbal assembly 32.

The workpiece 12 can then be adjusted within the gimbal assembly 32 (when the various components of the gimbal assembly 32 are loosened so as to allow movement of the central support body 34, which holds the workpiece 12, therewithin, as described below) into a desired position relative to the chuck 21, thus mimicking the position of the workpiece 12 relative to the gimbal assembly 32 when the gimbal assembly 32 is transferred to the chuck of the machine 14. The method can then include locking the gimbal assembly 32 (via tightening the components of the gimbal assembly 32 so that the central support body 34 cannot move relative to the components of the gimbal assembly 32, as described below) so as to lock the workpiece 12 in position relative to the gimbal assembly 32 and thus relative to the chuck 21. The gimbal assembly 32 can then be inserted into the machine 14 along with the workpiece 12 for machining of the workpiece 12.

In order to be able to adjust the workpiece 12 with six degrees of freedom, the gimbal assembly 32 includes a central support body 34 configured to fixedly hold the workpiece 12, a base support body 44 configured to be located in the chuck 21 and fixedly arranged therein, or the base platform 20 in some embodiments, and at least one adjustable body (i.e. first, second, and third annular rings 54, 64, 74) that is movable relative to the base support body 44 and that also support the central support body 34. Selective movement of the at least one adjustable body (i.e. in some embodiments, rotation of the first, second, and third annular rings 54, 64, 74) causes or enables movement of the central support body 34 relative to the base support body 44 in one or more of the six degrees of freedom so as to adjust a position of the workpiece 12 relative to the base support body 44, and thus relative to the chuck 21 of the tool base 18. It is noted that the annular rings 54, 64, 74 may also be referred to as adjustable bodies herein (i.e. “first adjustable body,” “second adjustable body,” and “third adjustable body”).

Illustratively, the at least one adjustable body can include first, second, and third annular rings 54, 64, 74 that are arranged concentrically with one another and stacked in a configuration in which the first annular ring 54 is a lowermost ring of the three annular rings and is arranged on the base support body 44, the second annular ring 64 is an uppermost ring of the three annular rings, and the third annular ring 74 is a middle ring of the three annular rings arranged between the first and second annular rings 54, 64. As will be described in greater detail below, the rings 54, 64, 75 can be rotated relative to each other, and the base support body 44 can be adjusted via the clamps 46A, 46B, in order to adjust the central support body 34, and thus the workpiece 12, with six degrees of freedom.

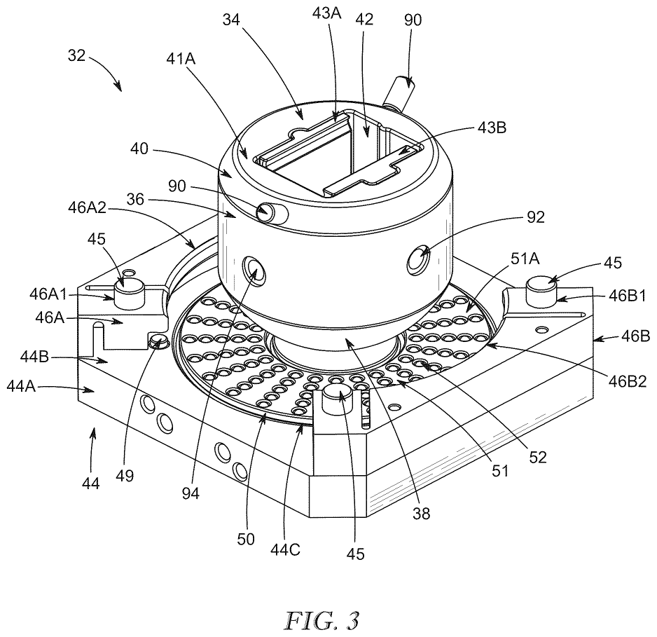

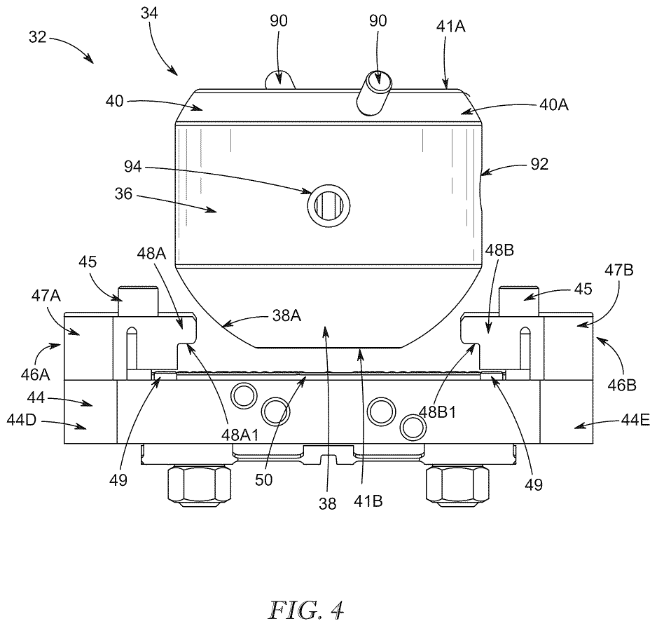

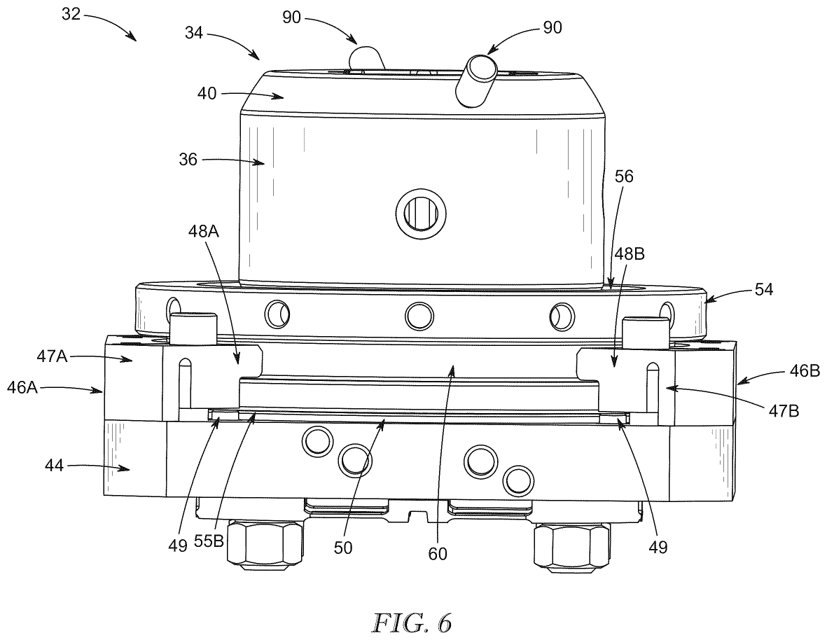

As can be seen in FIG. 3, the central support body 34 includes a main body portion 36 which may be formed as a cylindrical body. The central support body 34 further includes an annular lower portion 38 and an annular upper portion 40, each of which are sloped inwardly. Specifically, the annular lower portion 38 is sloped inwardly such that the lowermost side of the lower portion 38 has a smaller diameter than an uppermost side adjacent to the main body portion 36. Similarly, the annular upper portion 40 is sloped inwardly such that the uppermost side of the upper portion 40 has a smaller diameter than a lowermost side adjacent to the main body portion 36. In some embodiments, the axial extent of the annular upper portion 40 is smaller than an axial extent of the annular lower portion 38, the axial extent being measured along a central axis of the main body portion 36 (i.e. an upward-downward direction as shown in FIG. 4). As such, a diameter of an upper surface 41A of the central support body 34 is greater than a diameter of a bottom surface 41B of the central support body 34. It is noted that “sloped” refers to the contour of these surfaces when viewed in cross-section or in a side-view direction (i.e. as shown in FIGS. 4, 8, 10, and 11). Because the surfaces 38, 40, as well as the other similarly sloped surfaces 67, 80B are annular, the sloped nature of these surfaces is partially spherical, as can be seen, for example, in FIGS. 3 and 5A-6.

As can be seen in FIG. 4, the outer surface 38A of the annular lower portion 38 is sloped and includes a slight curvature. In other words, the annular lower portion 38 is tapered with a slightly curved taper. As will be described in greater detail below and as can be seen in FIG. 8, the curved outer surface 38A corresponds to a curved, tapered inner surface 80B (also referred to as a “sloped bottom portion”) of a central annular cavity 80 of the third annular ring 74 to allow for rotation of the central support body 34 within the third annular ring 74. Illustratively, the surface area of the outer surface 38A is larger than the surface area of an outer surface 40A of the annular upper portion 40 to allow for more freedom when rotating the central support body 34 within the annular rings 64, 74.

The central support body 34 further includes a central cavity 42 that extends centrally and axially through the body 34, and within which the workpiece 12 can be fixedly arranged. The central support body 34 can further include first and second support pads 43A, 43B that can surround a portion of the workpiece 12 when arranged in the cavity 42 and provide additional support to the portion of the workpiece 12. In some embodiments, the central support body 34 can further include first and second holes 92, 94 that extend radially from the outer surface of the main body portion 36 and into the cavity 42. In some embodiments, one hole 92 may extend from the outer surface of the main body portion 36 and open at one of the pads 43B, and the other hole 94 may be offset 90 degrees and extend from the outer surface of the main body portion 36 and open at an inner surface of the cavity 42, as shown in FIG. 9.

Fasteners can be inserted through the holes 92, 94 so as to further support the workpiece 12 within the central support body 34. For example, a fastener can be inserted in and extend through the hole 92 to push on the pad 43B and thus push the pad 43B against the workpiece 12. Another fastener can be inserted in and extend through the hole 94 to push on a different side of the workpiece 12. In some embodiments, the central support body 34 can include removable pins and/or threaded fasteners 90 that can be inserted through holes 72 formed in the second annular ring 64 and into the annular upper portion 40 so as to lock the central support body 34 in position relative to the annular rings 54, 64, 74.

Referring to FIG. 3, the base support body 44 includes a base 44A formed as a planar platform upon which the remaining components of the gimbal assembly 32 are arranged. The base 44A includes an upper surface 44B having a shallow central annular recess 44C formed therein. The base 44A can be formed as a square or similar quadrilateral so long as the upper surface 44B fits the central annular recess 44C. An annular disk 50 is arranged in the central annular recess 44C and includes an upper surface 51 that is located slightly above the upper surface 44B when the annular disk 50 is arranged in the central annular recess 44C, as shown in FIG. 4. The upper surface 51 of the annular disk 50 is configured to support a bottom surface 55B of the first annular ring 54 and allow the first annular ring 54 to be translated or slid along the surface 51 when the clamps 46A, 46B are loosened, as will be described in detail below. In some embodiments, the annular disk 50 can further include a plurality of spherical roller balls 52 arranged in recesses formed in the upper surface 51. The roller balls 52 can extend from a central area in a ray-like fashion, as shown in FIG. 4. In some embodiments, the base support body 44 can further include support pads 49 arranged outside of the central annular recess 44C configured to provide further support to the bottom surface 55B of the first annular ring 54. The support pads 49 can be adjustable in the upward-downward directions 98, 99.

As shown in FIGS. 3 and 4, the base support body 44 can further include a first clamp 46A arranged on a first side 44D of the base support body 44 and selectively fastened to the base support body 44 via at least one first fastener 45 extending through holes 46A1 in the clamp 46A. The base support body 44 can further include a second clamp 46B arranged on a second side 44E of the base support body 44 opposite the first and selectively fastened to the base support body 44 via at least one second fastener 45 extending through holes 46B1 in the clamp 46B.

The first clamp 46A includes a main body 47A and a first curved flange 48A that extends along a length of the first clamp 46A and has a curved surface 46A2 that generally matches a curvature of an annular groove 60 formed in the first annular ring 54. The second clamp 46B includes a main body 47B and a second curved flange 48B that extends along a length of the second clamp 46B and has a curved surface 46B2 that also generally matches a curvature of the annular groove 60. In this way, the first and second curved flanges 48A, 48B extend into the groove 60 to locate the first annular ring 54 on the upper surface 51 of the annular disk 50.

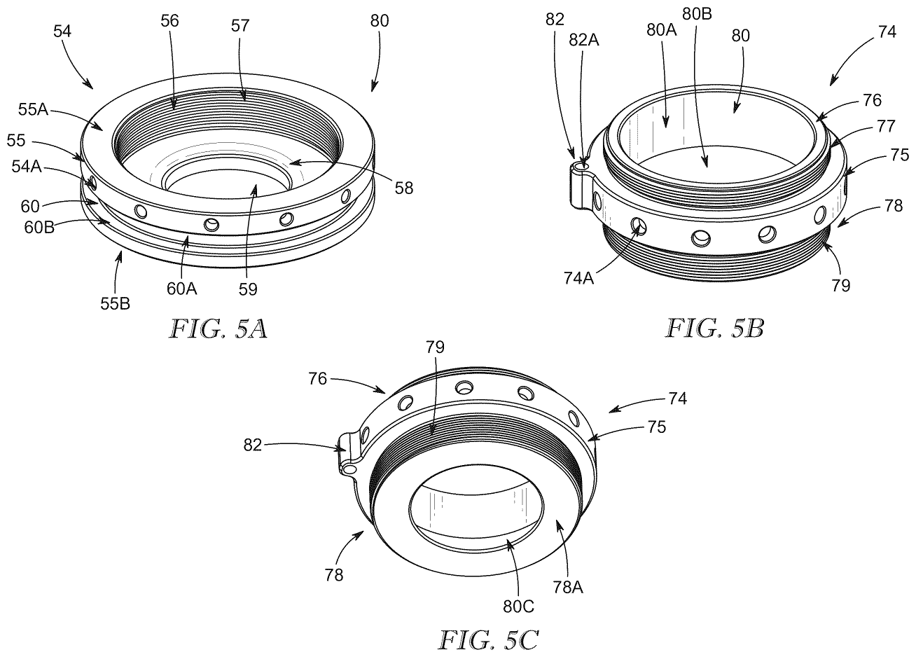

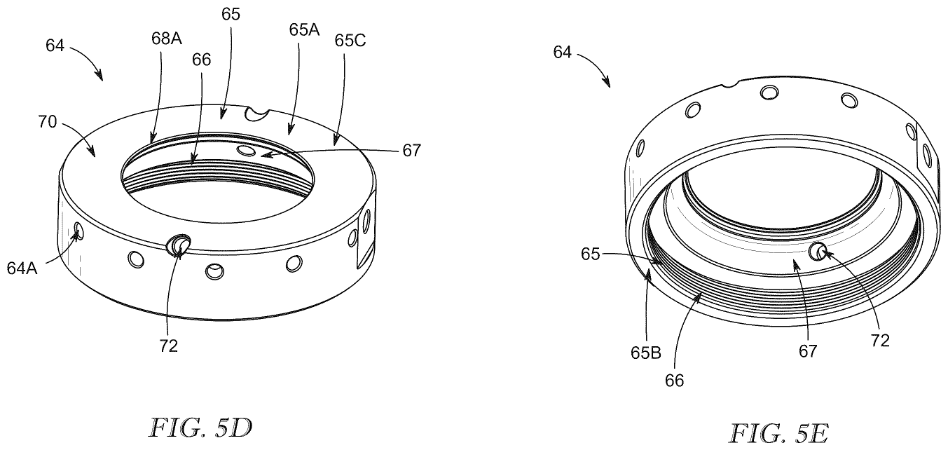

As noted above, the first annular ring 54 can be translated or slid along the surface 51 when the clamps 46A, 46B are loosened. Specifically, the at least one first and second fasteners 45 can be tightened and loosened so as to selectively arrange the first annular ring 54 in a tightened or loosened state. For example, in the loosened state, lower inner surfaces 48A1, 48B1 (see FIG. 4) of the first and second flanges 48A, 48B are slightly spaced apart from a bottom surface 60B (see FIG. 5A) of the groove 60 such that the first annular ring 54 can be translated left-to-right 105, right-to-left 104, forward-to-backward 102, and backward-to-forward 103 on the upper surface 44B of the base support body 44 (i.e. the upper surface 51 of the annular disk 50).

As shown in FIG. 5A, the first annular ring 54 includes an annular body 55 having an upper annular surface 55A and the bottom surface 55B. A plurality of holes 54A can be formed in the annular body 55 to allow for tools to be inserted therein in order to assist in rotating the ring 54. The annular body 55 includes a threaded inner surface 57 defining a central cavity 56 of the ring 54. The ring 54 further includes an annular flange 58 arranged at a lowermost side of the inner surface 57 having a central opening 59. The bottom surface 55B may be at least partially defined by a bottom surface of the annular flange 58, as can be seen in FIG. 8.

As can also be seen in FIG. 8, the first annular ring 54 is arranged partially below the central support body 34, in particular the annular flange 58 being mostly below the central support body 34 while the threaded inner surface 57 is arranged generally aligned with the annular lower portion 38 of the central support body 34. As noted above, the first annular ring 54 is rotatable relative to the base support body 44 on the upper surface 44B and the upper surface 51 of the annular disk 50. The first annular ring 54 indirectly supports the central support body 34 via the threaded engagement of the threaded inner surface 57 and the lower threaded outer surface 79 of the third annular ring 74. The interaction of the first annular ring 54 with the second and third annular rings 64, 74 and the central support body 34 will be described in greater detail below, in particular the manner in which the first annular ring 54 can be rotated to raise and lower the central support body 34 relative to the base support body 44.

As can be seen in FIGS. 5D, 5E, and 8, the second annular ring 64 is formed similarly to the first annular ring 54 in that the ring 64 includes an annular body 65 having an upper annular surface 65A and the bottom surface 65B. A plurality of holes 64A can be formed in the annular body 65 to allow for tools to be inserted therein in order to assist in rotating the ring 64. The annular ring 64 includes a threaded lower inner surface 66 and a sloped annular upper portion 67 corresponding to the sloped annular upper portion 40 of the central support body 34 and defining a central cavity 68 of the ring 64. An annular flange 65C extends around an upper side of the ring 64 such that an upper surface of the flange 65C defines the upper surface 65A of the ring 64. As can be seen in FIGS. 5D and 5E, the diameter of the cavity 68 is largest in the area of the threaded lower inner surface 66 and gets smaller as it approaches the upper opening 68A of the cavity 68 due to the sloped annular upper portion 40.

As can be seen in FIG. 8, the second annular ring 64 surrounds the central support body 34 and that is rotatable independently of the first annular ring 54, the third annular ring 74, and relative to the base support body 44. The sloped annular upper portion 67 corresponds to the sloped annular upper portion 40 of the central support body 34, in particular, in some embodiments, with both the upper portion 67 and upper portion 40 being tapered with a very slightly curved taper (i.e. less of a curvature, or in other words, a greater radius of curvature, than the annular lower portion 38).

Illustratively, the second annular ring 64 functions to tighten and loosen its grip on the central support body 34 so as to allow and restrict movement of the central support body 34 within the annular rings 54, 64, 74, and thus relative to the base support body 44 and relative to the chuck 21. Specifically, rotating the second annular ring 34 relative to the third annular ring 74 between tightened and loosened positions, where movement of the central support body 34 is enables in the loosened position of the ring 64 and movement of the central support body 34 is restricted in the tightened position of the ring 64. The interaction of the second annular ring 64 with the first and third annular rings 54, 74 and the central support body 34 will be described in greater detail below. Although a rotatable annular ring is described in detail herein, other means of securing the central support body 34 relative to the other rings 54, 74 and the base support body 44 are contemplated by the present disclosure, such as via a simplified clamp mechanism arranged on an upper side of the third annular ring 74 that clamps down on the upper portion 40 of the central support body 34 and can be selectively moved between tightened and loosened positions.

As can be seen in FIGS. 5B, 5C, and 8, the third annular ring 74 is formed similarly to the first and second annular rings 54, 64, but different in that the ring 74 includes two threaded surfaces (upper threaded outer surface 77 and lower threaded outer surface 79) instead of a single threaded surface, and that the ring 74 includes threaded surface on an outer side of the ring 74 so that the threads can engage with the threads of the first and second annular rings 54, 64.

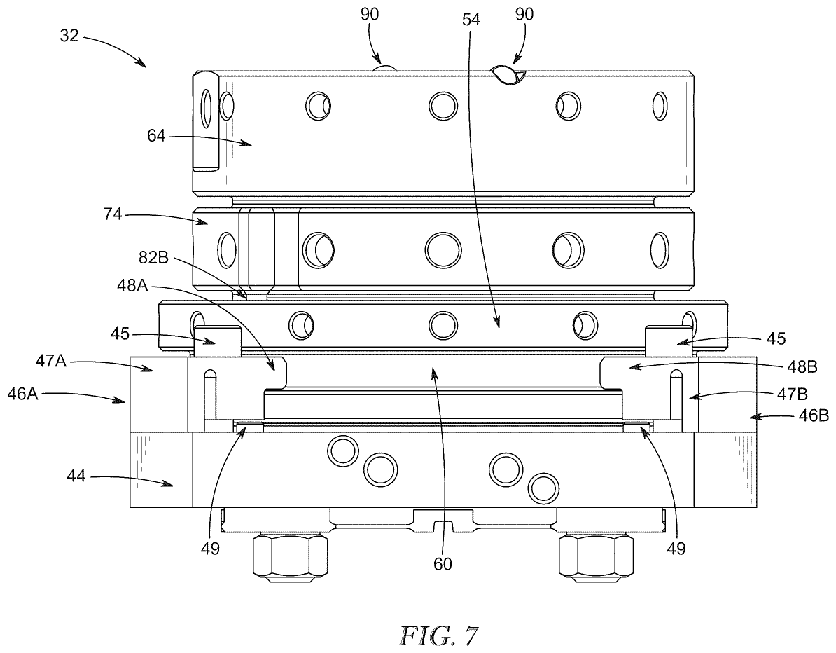

Illustratively, the third annular ring 74 includes a central annular body 75 having an upper portion 76 on an upper side of the central annular body 75 and a lower portion 78 on a lower side of the central annular body 75. The central annular body 75 has a greater diameter than the upper and lower portions 76, 78 such that the central annular body 75 forms an annular flange around the ring 74. A plurality of holes 74A can be formed in the annular body 75 to allow for tools to be inserted therein in order to assist in rotating the ring 74. The central annular body 75 further includes a protrusion 82 having a hole 82A extending therethrough in an axial direction (direction through a central axis of the ring 74, an upward-downward direction as viewed in FIG. 5B). A fastener 82B (see FIG. 7) can be inserted through the hole 82A and into contact with the upper surface 55A of the first annular ring 54, thus aiding in securing the position of the third annular ring 74 relative to the first annular ring 54.

As shown in FIGS. 5B, 5C, and 8, the upper portion 75 includes the upper threaded outer surface 77 and the lower portion 78 includes the lower threaded outer surface 79. The ring 74 includes a central cavity 80 defined within the upper portion 77, the central annular body 75, and the lower portion 78, the central support body 34 being arranged within the central cavity 80 and supported thereby. The central cavity 80 includes an upper cylindrical portion 80A and a curved, tapered inner surface 80B (also referred to as a “sloped bottom portion”). The sloped bottom portion 80B corresponds to the curvature of the curved outer surface 38A of the central support body 34 so as to both support the central support body 34 thereon and also allow for movement of the central support body 34 within the cavity 80 in at least the positive and negative pitch directions 96, 97, the positive and negative roll directions 100, 101, and the positive and negative yaw directions 106, 107. The upper cylindrical portion 80A has a constant diameter that is slightly greater than the diameter of the main body portion 36 so as to allow for the above-described movement of the central support body 34 within the cavity 80. The ring 74 further includes an annular flange 78A on a bottom side of the ring 74 such that the sloped bottom portion 80B opens downwardly via an opening 80C of the annular flange 78A that has a diameter that is smaller than a diameter of the upper cylindrical portion 80A.

FIGS. 7-9 illustrate how the base support body 44 and the three annular rings 54, 64, 74 cooperate to enable and restrict adjustments in positioning of the central support body 34 to be made, and thus adjustments in positioning of the workpiece 12 relative to the chuck 21. FIG. 7 shows an assembled view of the gimbal assembly 32 with the three annular rings 54, 64, 74 arranged to surround the central support body 34, FIG. 8 shows a front cross-sectional view of the gimbal assembly 32 with the central support body 34 in a neutral position, and FIG. 9 shows a top cross-sectional view of the gimbal assembly 32 with the central support body 34 in the neutral position.

As can be seen in FIG. 8, the first and second curved flanges 48A, 48B of the first and second clamps 46A, 46B extend into the groove 60 of the first annular ring 54 so as to guide the ring 54 when it is rotated relative to the base support body 44. The first annular ring 54 rests of the annular disk 50 and can be rotated and moved relative thereto. The threaded inner surface 57 of the first annular ring 54 engages the lower threaded outer surface 79 of the third annular ring 74, and the threaded lower inner surface 66 engages the upper threaded outer surface 77.

In operation, the first and second clamps 46A, 46B and the three annular rings 54, 64, 74 can each be selectively manipulated and moved in order to adjust the central support body 34 with the six degrees of freedom described above. Specifically, the first and second clamps 46A, 46B can be tightened and loosened on the base support body 44 to allow for movement of the annular rings 54, 64, 74, and thus the central support body 34, left-to-right 105, right-to-left 104, forward-to-backward 102, and backward-to-forward 103, as shown in FIG. 9. As noted above, the fasteners 45 can be tightened and loosened, where loosening the fasteners 45 allows the first and second clamps 46A, 46B to raise upwardly slightly in the direction 99 shown in FIG. 8.

When the first and second clamps 46A, 46B are raised, the clamps 46A, 46B are in the loosened state in which the lower inner surfaces 48A1, 48B1 (see FIG. 4) of the first and second flanges 48A, 48B are slightly spaced apart from the bottom surface 60B (see FIG. 5A) of the groove 60 such that the first annular ring 54 can be translated left-to-right 105, right-to-left 104, forward-to-backward 102, and backward-to-forward 103 on the upper surface 44B of the base support body 44 (i.e. the upper surface 51 of the annular disk 50). In other words, as shown in FIG. 9, in the loosened state of the first annular ring 54, the first annular ring 54 can be translated left-to-right 105, right-to-left 104, forward-to-backward 102, and backward-to-forward 103. In the tightened state, the clamps 46A, 46B are lowered enough in the direction 98 such that the lower inner surfaces 48A1, 48B1 (see FIG. 4) of the first and second flanges 48A, 48B exert enough pressure on the bottom surface 60B (see FIG. 5A) of the groove 60 so as to hold the first annular ring 54 in a fixed position on the base support body 44.

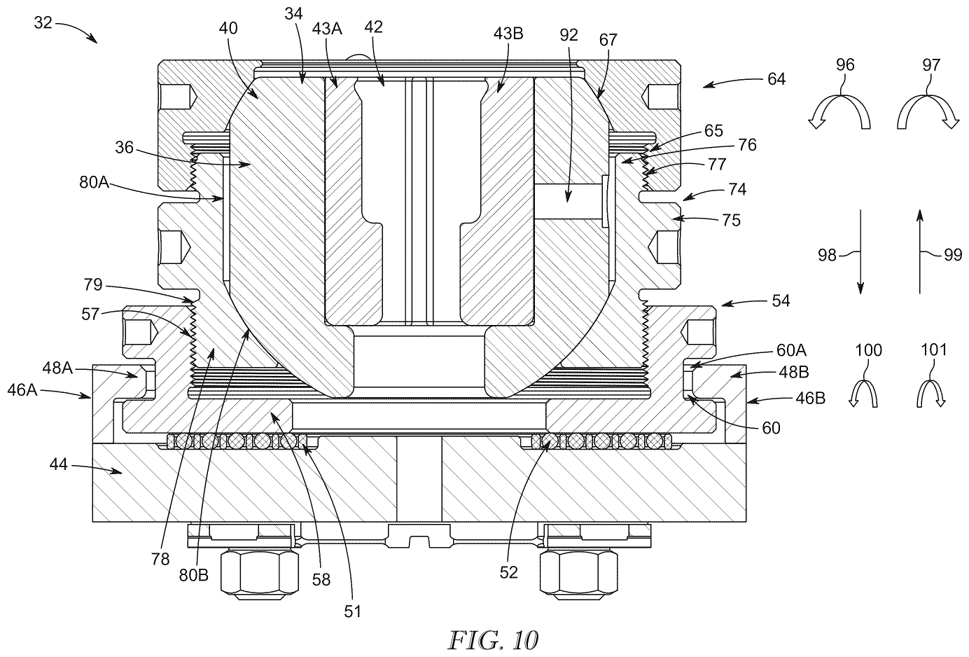

In order to move the central support body 34 in the upward direction 99 and in the downward direction 98, the first annular ring 54 can be rotated relative to the third annular ring 74, as shown in FIG. 8. Specifically, the threads of the threaded inner surface 57 of the first annular ring 54 engage the threads of the lower threaded outer surface 79. The third annular ring 74 can be maintained relatively stationary, in some embodiments by external means or holding force, while the first annular ring 54 is selectively rotated such that the rotation of the first annular ring 54 causes the third annular ring 74, and thus the central support body 34 arranged in the cavity 80 therein, to move in either the upward direction 99 or in the downward direction 98. In some embodiments, rotation of the first annular ring 54 in a first rotational direction causes the third annular ring 74 to move in the upward direction 99. FIG. 10 shows the third annular ring 74 raised relative to the first annular ring 54 (i.e. in a raised position) after the first annular ring 54 has been rotated in the first rotational direction. Rotation of the first annular ring 54 in a second rotational direction opposite the first rotational direction causes the third annular ring 74 to move in the downward direction 98.

Finally, in order to allow adjustment of the central support body 34 within the three annular rings 54, 64, 74, the second annular ring 64 can be tightened or loosened on the annular upper portion 40 of the central support body 34. Specifically, the second annular ring 64 can be selectively rotated in a first rotational direction such that the threaded engagement of the upper threaded outer surface 77 and the threaded lower inner surface 66 lowers the second annular ring 64 in the downward direction 98. This moves the second annular ring 64 into a tightened position in which the sloped annular upper portion 67 contacts the annular upper portion 40 of the central support body 34 and thus holds the central support body in a fixed position relative to the base support body 44.

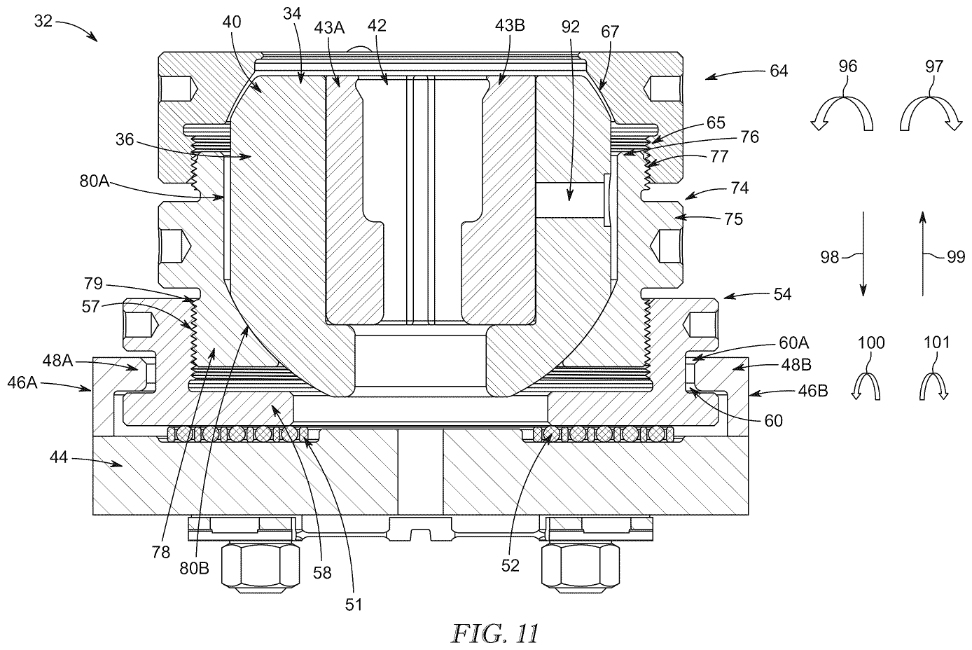

Conversely, the second annular ring 64 can be selectively rotated in a second rotational direction opposite the first rotational direction such that the threaded engagement of the upper threaded outer surface 77 and the threaded lower inner surface 66 raises the second annular ring 64 in the upward direction 99. This moves the second annular ring 64 into a loosened position in which the sloped annular upper portion 67 is slightly spaced apart from the annular upper portion 40 of the central support body 34 such that the second annular ring 64 allows for movement of the central support body 34 relative to the second annular ring 64 and the base support body 44. FIG. 11 shows the second annular ring 64 raised relative to the third annular ring 74 (i.e. in a raised position) after the second annular ring 64 has been rotated. As can be seen in FIGS. 8, 9, and 11, the sloped annular upper portion 67 being spaced apart from the annular upper portion 40 allows for the central support body 34 to be moved in positive and negative pitch directions 96, 97, positive and negative roll directions 100, 101, and positive and negative yaw directions 106, 107. This can be accomplished via external means such as a user manually adjusting the central support body 34 within the cavity 80 when the gimbal assembly 32 is arranged in the chuck 21 of the tool base 18 (“loading station”). After adjustments are made, the second annular ring 64 can be tightened and the central support body 34 is secured in a second position different than the neutral position, and thus in a new position relative to the chuck 21. After the central support body 34 is secured, the gimbal assembly 32 and the workpiece 12 can then be inserted into the machine 14 for machining of the workpiece 12.

A method according to the present disclosure includes providing a base support body 44 of a gimbal assembly 32, arranging at least one adjustable body (annular rings 54, 64, 74) on the base support body 44, the at least one adjustable body (annular rings 54, 64, 74) being supported by the base support body 44 and is movable relative thereto, arranging a central support body 34 at least partially within the at least one adjustable body (annular rings 54, 64, 74) such that the at least one adjustable body (annular rings 54, 64, 74) at least partially supports the central support body 34, fixedly arranging a workpiece 12 configured to be modified by a machine 14 in the central support body 34, and selectively moving the at least one adjustable body (annular rings 54, 64, 74) relative to the base support body 44 so as to cause or enable movement of the central support body 34 relative to the base support body 44 in one or more of the six degrees of freedom so as to adjust a position of the workpiece 12 relative to the base support body 44.

The method can further include rotating the first adjustable body (first annular ring 54) in a first rotational direction so as to cause the central support body 34 to move in an upward direction relative to the base support body 44, and rotating the first adjustable body (first annular ring 54) in a second rotational direction opposite the first rotational direction so as to cause the central support body 34 to move in a downward direction opposite the upward direction relative to the base support body 44.

The method can further include arranging the central support body 34 in a neutral position within the first and second adjustable bodies (first and second annular rings 54, 64), rotating the second adjustable body in the second rotational direction to a loosened position in which the second adjustable body (second annular ring 64) is slightly spaced apart from the central support body 34 and allows for movement of the central support body 34 relative to the second adjustable body (second annular ring 64) and the base support body 44, adjusting a position of the central support body 34 relative to the first and second adjustable bodies (first and second annular rings 54, 64) and the base support body 44 to a second position different than the neutral position, and rotating the second adjustable body (second annular ring 64) in the first rotational direction to a tightened position in which the second adjustable body (second annular ring 64) contacts the central support body 34 and holds the central support body 34 in a fixed position relative to the first and second adjustable bodies (first and second annular rings 54, 64) and the base support body 44, the fixed position being the second position.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A machine tool system comprising
a thin-walled three-dimensional workpiece,
a machine configured to modify the thin-walled three-dimensional workpiece, the machine including a shaft configured to move along a first axis, and
a tool base configured to support the thin-walled three-dimensional workpiece, the tool base including a gimbal assembly that supports the thin-walled three-dimensional workpiece and that enables adjustment of the thin-walled three-dimensional workpiece with six degrees of freedom, the gimbal assembly being configured to be arranged in the machine for machining the thin-walled three-dimensional workpiece, the gimbal assembly including a base support body and at least one adjustable body supported by the base support body and movable relative thereto, the gimbal assembly further including a central support body arranged at least partially within and supported by the at least one adjustable body, the central support body configured to fixedly hold the thin-walled three-dimensional workpiece, wherein the shaft is movable relative to the gimbal assembly when the gimbal assembly is arranged in the machine so as to modify the thin-walled three-dimensional workpiece,
wherein the at least one adjustable body is configured to be selectively moved relative to the base support body, wherein selective movement of the at least one adjustable body causes or enables movement of the central support body relative to the base support body in one or more of the six degrees of freedom so as to adjust a position of the thin-walled three-dimensional workpiece relative to the base support body.

2. The machine tool system of claim 1, wherein the at least one adjustable body includes a first adjustable body that is arranged partially below the central support body and that is movable relative to the base support body, wherein the first adjustable body supports the central support body, and wherein rotation of the first adjustable body in a first rotational direction causes the central support body to move in an upward direction relative to the base support body and rotation of the first adjustable body in a second rotational direction opposite the first rotational direction causes the central support body to move in a downward direction opposite the upward direction relative to the base support body.

3. The machine tool system of claim 2, wherein the at least one adjustable body further includes a second adjustable body that surrounds the central support body and that is rotatable independently of the first adjustable body and relative to the base support body, and wherein the second adjustable body is configured to be rotated relative to the first adjustable body in a first rotational direction to a tightened position in which the second adjustable body contacts the central support body and holds the central support body in a fixed position relative to the base support body, and is configured to be rotated in a second rotational direction opposite the first rotational direction to a loosened position in which the second adjustable body is spaced apart from the central support body to allow for movement of the central support body relative to the second adjustable body and the base support body.

4. The machine tool system of claim 3, wherein the second adjustable body being in the loosened position allows for the central support body to move in positive and negative yaw directions, positive and negative roll directions, and positive and negative pitch directions.

5. The machine tool system of claim 4, wherein the first adjustable body rests on and is supported by an upper surface of the base support body and includes a bottom surface that is configured to slide along the upper surface such that the first adjustable body can rotate on the upper surface.

6. The machine tool system of claim 5, wherein the at least one adjustable body further includes a third adjustable body arranged between the first and second adjustable bodies in a vertical direction, wherein the third adjustable body surrounds the central support body and includes an opening therethrough having a sloped bottom portion that supports the central support body therein, and wherein the first adjustable body engages the third adjustable body such that rotation of the first adjustable body in the first rotational direction moves the third adjustable body in the upward direction so as to move the central support body in the upward direction.

7. The machine tool system of claim 3, wherein the first adjustable body is a first annular ring including a bottom surface that rests on an upper surface of the base support body and is configured to slide along the upper surface such that the first annular ring can rotate on the upper surface, and wherein the second adjustable body is a second annular ring that surrounds the central support body.

8. The machine tool system of claim 7, wherein the at least one adjustable body further includes a third adjustable body that is a third annular ring that surrounds the central support body and is arranged between the first and second annular rings in a vertical direction, wherein the third annular ring includes an inner surface that supports the central support body, and wherein the first annular ring includes a threaded inner surface and the third annular ring includes a lower threaded outer surface that engages the threaded inner surface of the first annular ring such that rotation of the first annular ring in the first rotational direction moves the third annular ring in the upward direction so as to move the central support body in the upward direction.

9. The machine tool system of claim 8, wherein the second annular ring is configured to be rotated in a first rotational direction to a tightened position in which an inner surface of the second annular ring contacts the central support body and holds the central support body in a fixed position relative to the base support body, and is configured to be rotated in a second rotational direction opposite the first rotational direction to a loosened position in which the second annular ring is spaced apart from the central support body to allow for movement of the central support body relative to the second annular ring and the base support body.

10. The machine tool system of claim 9, wherein the central support body includes a sloped annular upper portion and a sloped annular lower portion, wherein the inner surface of the third annular ring includes a sloped bottom portion that supports the sloped annular lower portion of the central support body therein, wherein the sloped bottom portion and the sloped annular lower portion of the central support body have corresponding curvatures to allow for rotation of the central support body within the third annular ring, wherein the second annular ring includes an inner surface having a sloped annular upper portion corresponding to the sloped annular upper portion of the central support body, and wherein, in the tightened position of the second annular ring, the sloped annular upper portion of the second annular ring contacts and exerts a force on the sloped annular upper portion of the central support body so as to push the sloped annular lower portion into secure engagement with the sloped bottom portion of the third annular ring so as to hold the central support body in a fixed position relative to the first, second, and third annular rings and to the base support body.

11. The machine tool system of claim 10, wherein the inner surface of the second annular ring includes a threaded lower inner surface, wherein the third annular ring includes an upper threaded outer surface that engages the threaded lower inner surface of the second annular ring, and wherein the second annular ring is configured to be rotated relative to the third annular ring via the threaded lower inner surface and the upper threaded outer surface so as to move the second annular ring between the tightened and loosened positions.

12. The machine tool system of claim 7, wherein the gimbal assembly further includes a first clamp arranged on a first side of the base support body and selectively fastened to the base support body via at least one first fastener, and a second clamp arranged on a second side of the base support body opposite the first side and selectively fastened to the base support body via at least one second fastener, wherein the first annular ring includes an annular groove formed in an outer surface of the first annular ring, wherein the first clamp includes a first curved flange that extends into the groove and the second clamp includes a second curved flange that extends into the groove, wherein the at least one first and second fasteners are configured to tightened and loosened so as to selectively arrange the first annular ring in a tightened or loosened state, and wherein inner surfaces of the first and second flanges are spaced apart from a bottom surface of the groove such that, in the loosened state of the first annular ring, the first annular ring can be translated left-to-right, right-to-left, forward-to-backward, and backward-to-forward on the upper surface of the base support body.

13. The machine tool system of claim 1, wherein the tool base further includes a base platform and a chuck arranged on the base platform, wherein the gimbal assembly is configured to be arranged in the chuck prior arranging the gimbal assembly in the machine, and wherein the position of the thin-walled three-dimensional workpiece relative to the gimbal assembly is configured to be adjusted while the gimbal assembly is arranged in the chuck and locked in a locked position in the gimbal assembly such that the gimbal assembly and having the thin-walled three-dimensional workpiece arranged therein is configured to be arranged in the machine with the thin-walled three-dimensional workpiece in the locked position.

14. A gimbal assembly for supporting a workpiece relative to a machine configured to modify the workpiece, comprising
a base support body,
at least one adjustable body supported by the base support body and movable relative thereto, and
a central support body arranged at least partially within and supported by the at least one adjustable body, the central support body configured to fixedly hold a workpiece,
wherein the at least one adjustable body is configured to be selectively moved relative to the base support body, and wherein selective movement of the at least one adjustable body causes or enables movement of the central support body relative to the base support body in one or more of the six degrees of freedom so as to adjust a position of the workpiece relative to the base support body.

15. The gimbal assembly of claim 14, wherein the at least one adjustable body includes a first adjustable body that is arranged partially below the central support body and that is rotatable relative to the base support body, wherein the first adjustable body supports the central support body, and wherein rotation of the first adjustable body in a first rotational direction causes the central support body to move in an upward direction relative to the base support body and rotation of the first adjustable body in a second rotational direction opposite the first rotational direction causes the central support body to move in a downward direction opposite the upward direction relative to the base support body.

16. The gimbal assembly of claim 15, wherein the at least one adjustable body further includes a second adjustable body that surrounds the central support body and that is rotatable independently of the first adjustable body and relative to the base support body, wherein the second adjustable body is configured to be rotated in a first rotational direction to a tightened position in which the second adjustable body contacts the central support body and holds the central support body in a fixed position relative to the base support body, and is configured to be rotated in a second rotational direction opposite the first rotational direction to a loosened position in which the second adjustable body is spaced apart from the central support body to allow for movement of the central support body relative to the second adjustable body and the base support body, and wherein the first adjustable body rests on and is supported by an upper surface of the base support body and includes a bottom surface that is configured to slide along the upper surface such that the first adjustable body can rotate on the upper surface.

17. The gimbal assembly of claim 16, wherein the at least one adjustable body further includes a third adjustable body arranged between the first and second adjustable bodies in a vertical direction, wherein the third adjustable body surrounds the central support body and includes an opening therethrough having a sloped bottom portion that supports the central support body therein, and wherein the first adjustable body engages the third adjustable body such that rotation of the first adjustable body in the first rotational direction moves the third adjustable body in the upward direction so as to move the central support body in the upward direction.

18. A method comprising
providing a base support body of a gimbal assembly,
arranging at least one adjustable body on the base support body, wherein the at least one adjustable body is supported by the base support body and is movable relative thereto,
arranging a central support body at least partially within the at least one adjustable body such that the at least one adjustable body at least partially supports the central support body,
fixedly arranging a workpiece configured to be modified by a machine in the central support body, and
selectively moving the at least one adjustable body relative to the base support body so as to cause or enable movement of the central support body relative to the base support body in one or more of the six degrees of freedom so as to adjust a position of the workpiece relative to the base support body.

19. The method of claim 18, wherein the at least one adjustable body includes a first adjustable body that is arranged partially below the central support body and that is rotatable relative to the base support body, wherein the first adjustable body supports the central support body, and wherein the method further includes
rotating the first adjustable body in a first rotational direction so as to cause the central support body to move in an upward direction relative to the base support body, and
rotating the first adjustable body in a second rotational direction opposite the first rotational direction so as to cause the central support body to move in a downward direction opposite the upward direction relative to the base support body.

20. The method of claim 19, wherein the at least one adjustable body further includes a second adjustable body that surrounds the central support body and that is rotatable independently of the first adjustable body and relative to the base support body, wherein the second adjustable body is configured to be rotated in a first rotational direction and a second rotational direction opposite the first rotational direction, and wherein the method further includes
arranging the central support body in a neutral position within the first and second adjustable bodies,
rotating the second adjustable body in the second rotational direction to a loosened position in which the second adjustable body is slightly spaced apart from the central support body and allows for movement of the central support body relative to the second adjustable body and the base support body,
adjusting a position of the central support body relative to the first and second adjustable bodies and the base support body to a second position different than the neutral position, and
rotating the second adjustable body in the first rotational direction to a tightened position in which the second adjustable body contacts the central support body and holds the central support body in a fixed position relative to the first and second adjustable bodies and the base support body, the fixed position being the second position.
